(19) United States
(12) Patent Application Publication
(10) Pub. No.: US 2019/0171755 A1
(43) Pub. Date: Jun. 6, 2019

(54) SYSTEMS AND METHODS FOR DETERMINING RELEVANCE OF PLACE DATA

(71) Applicant: Uber Technologies, Inc., San Francisco, CA (US)

(72) Inventors: Livia Zarnescu Yanez, Menlo Park, CA (US); Shivendra Pratap Singh, Redwood City, CA (US); Chandan Sheth, San Francisco, CA (US); Alvin AuYoung, San Jose, CA (US); Sheng Yang, Fremont, CA (US); Vikram Saxena, Cupertino, CA (US)

(21) Appl. No.: 15/829,487

(22) Filed: Dec. 1, 2017

(51) Int. Cl. G06F 17/30; G06N 7/00

(52) U.S. Cl. CPC G06F 17/30601; G06N 7/005; G06F 17/3053

(57) ABSTRACT

Various embodiments determine relevance of place data by determining whether a place record is relevant based on a set of features associated with the place record. For a given place record, a set of features may be generated based on values of one or more attributes included in the given place record. A given place record may be processed by at least one machine learning model, such as a classifier, which receives as input a set of features of the given place record and outputs a prediction score indicating the certainty or probability that the given place record is associated with, or belongs to, a particular class. The certainty/probability of association between a given place record and a particular class can assist some embodiments in determining (e.g., predicting) whether the given place record is relevant or non-relevant for an intended use, such as a software application for a ride service.

### TECHNICAL FIELD

The described embodiments generally relate to map data and, more particularly, to systems, methods, and machines for determining relevance of data regarding (e.g., that describes) one or more places on a geographic map.

### BACKGROUND

Beyond just address and road information, certain map-based services operate by using additional information regarding locations on a geographic map, such as whether a location on the geographic map is a place of business and, if so, whether the business is still open, what are its business hours, what type of business is it, whether the business is accessible from a location from a public road, and whether the business is accessible by the public. Such additional information is usually included in, or provided as, place information. Map-based services, such as a ride service, a ride-sharing service, or a delivery service, may require place information for operation or may use place information to improve the quality of results, accuracy of results, or overall performance.

Unfortunately, the usefulness of place information can be highly dependent on its accuracy and relevance, and place information accuracy can vary between different data sources providing place information, and place information relevance can depend on accuracy (e.g., inaccurate place information is not relevant for use). This is particularly true when a data source providing place information to the map-based service is maintained by a third party, or the place information data source is based on (e.g., populated or updated) by crowd sourcing.

### BRIEF DESCRIPTION OF THE DRAWINGS

Various ones of the appended drawings merely illustrate various embodiments of the present disclosure and cannot be considered as limiting its scope.

FIG. 1 is a block diagram illustrating an example networked computing environment 100 that includes a place data system, according to some embodiments.

FIG. 2 is a diagram illustrating an example relevance determination system for determining relevance of place data, according to some embodiments.

FIGS. 3-5 are flowcharts illustrating example methods for determining relevance of place data, according to some embodiments.

FIG. 6 is a block diagram illustrating components of an example machine used to implement some embodiments.

The headings provided herein are merely for convenience and do not necessarily affect the scope or meaning of the terms used.

### DETAILED DESCRIPTION

The description that follows describes systems, methods, techniques, instruction sequences, and computing machine program products that illustrate various embodiments for determining relevance of data (hereafter, “place data”) regarding one or more places on a geographic map. For various embodiments described herein, place data is maintained as one or more place data records (hereafter, “place records”), where each place record can comprise data regarding a single place located on a geographic map (hereafter, “map”).

Various embodiments can determine relevance of place data by determining whether a place record, including the record's place data, is relevant based on a set of features associated with the place record. For a given place record, a set of features may be generated (e.g., derived or extracted) based on values of one or more attributes (e.g., record field or fields) included in the given place record. Accordingly, a set of features generated for a place record can represent information extracted from, or derived based on, one or more values provided by the place record with respect to a place on a map. For some embodiments, a given place record is processed by at least one classifier, which receives as input a set of features of the given place record and outputs a prediction score indicating the certainty or probability that the given place record is associated with, or belongs to, a particular class (e.g., class label). In this way, the at least one classifier can predict the association of the given place record to the particular class based on the set of features of the given place record, which can function as signals or suggestions for or against the class association. The certainty/probability of association between a given place record and a particular class assists some embodiments in determining whether the given place record is relevant or non-relevant. For instance, where the particular class indicates that the given place record is relevant, a prediction score for a given place record may represent the given place record's relevance score. Where the particular class indicates that the given place record is relevant, the prediction score can also represent the given place record's trustworthiness, which can determine how much weight is given to the given place record's attribute values.

Though various embodiments are described herein with respect to using a classifier to determine place record relevance, other embodiments may use other types of machine learning (ML) models instead of, or in addition to, the classifier. For some embodiments, the classifier comprises a binary classifier that can associate a place record to a positive or a negative class. Depending on the embodiment, the classifier may be implemented using logistic regression, random decision forest, or gradient boosted trees. For instance, an embodiment using gradient boosted trees can implement the classifier such that the classifier receives a category value as a feature (e.g., “education” category is associated with the value 1, “shops and services” category is associated with the value 2, “airport” category is associated with the value 3, etc.). Alternatively, each category may be represented by its own feature (e.g., “is_education” which can have a value of true or false, “is_shops_and_services” which can have a value of true or false, “is_airport” which can have a value of true or false, etc.), and the classifier may receive a set of such features.

In some embodiments, a relevance of a place record is determined relative to the place record's intended use, such as its use by a specific type of service. For instance, the relevance of the given place record may be determined based on whether the place record is, or would be, a relevant origin or destination for a location-based service, such as a mapping service, a transportation or transportation arrangement service (e.g., ride or ride-sharing service), a delivery service (e.g., package or food delivery), or a directory service.

With respect to use by a ride or ride-sharing service, for example, a given place record may be relevant if the given place record describes a place on a map that is open to the public and that a rider would want to go to. Examples of such places could include, without limitation, a restaurant, a hotel or motel, a public transit station, an airport, a venue (e.g., for sports or concert), a clinic, a hospital, a gym, a retail store, and an office building. With respect to use by a ride or ride-sharing service, a place record that describes a place that is closed may be relevant because it can be used to inform a rider that the place is closed (e.g., before the rider specifies that place as their intended destination). Additionally, with respect to use by a ride or ride-sharing service, a place record that inaccurately describes the location of a place may be relevant because it can help train a classifier of an embodiment in estimating the accuracy of one or more attribute values of the place record.

In regard to non-relevant place records, a place record may be non-relevant with respect to use by a ride or ride-sharing service if, for example, the place record describes a place that is a private location, such as an individual's home, or a small business run out of an individual's home. With respect to use by a ride or ride-sharing service, a place record may be non-relevant if the place record describes a temporary, one-time event or a short-time event. Additionally, with respect to use by a ride or ride-sharing service, a place record may be non-relevant if the place record describes a place that does not really exist. Examples of such non-relevant place records can include, without limitation, a place record that is vaguely named (e.g., “favorite sunset spot”), that refers to a flight or a trip, or that refers to a business no longer in operation.

Accordingly, for various embodiments, the classifier is built (e.g., trained) such that the classifier can identify the relevance of place records according to their intended use. The classifier may be built using training data comprising a set of place records having confirmed or trusted associations with class labels (e.g., confirmed associations with positive and negative class labels). For a given place record, a prediction score provided by the classifier can be used to identify whether the given place record is a non-relevant place record that should be filtered out before being used for its intended use, such as use by a networked computer system that facilitates a ride service, a ride-sharing service, a delivery service, or another type of location-based service. An embodiment may be particularly useful in filtering out non-relevant place records generated, maintained, or otherwise provided by a third party. For place records that are user-generated or user-maintained (e.g., crowd-sourced place records), which may be a type of place records provided by a third party, the place records may have attributes (e.g., fields) with missing, inaccurate (e.g., outdated), or fabricated information. For instance, a user-generated or user-maintained place record may include poor geocoding information or be missing information regarding what type of place is described. As a result, information extracted or derived from one or more attributes (e.g., during feature generation) may be noisy and vary in quality. Consequently, user-generated/maintained place records can include one or more place records that are not relevant (e.g., not desirable or useful) for their intended purpose, such as use by a networked computer system that facilitates a location-based service (e.g., ride or ride-sharing service).

Various embodiments described herein can improve the ability of a computer system to determine relevance of a place data that describes a place on a geographic map. Additionally, various embodiments described herein can assist in building a comprehensive database of relevant place data, which may be utilized to accurately describe potential destinations for a location-based service, such as a ride or ride-share service. Accordingly, various embodiments can also improve a computer system's ability to build a comprehensive database of relevant place data.

For example, an embodiment may be used in conjunction with a place data process pipeline used to process (e.g., ingest, match and combine, filter for relevance, and analyze for accuracy) place records obtained from a data source, such as a third-party data source for place data, prior to the place records being used in the comprehensive database. Where place records are sourced from multiple data sources (e.g., third-party providers), a place data process pipeline may comprise matched place records from the different data sources to identify place records that refer to the same physical location. Place records may be matched, for instance, based on one or more attribute values included in place records, such as place names, place addresses, place types, or place geographic coordinates. For each set of matched place records that results, the place data process pipeline can combine the information of the set of matched place records (e.g., by selecting the best latitude and longitude coordinates, best name, and best address) to output a single place record to describe the place corresponding to the physical location and originally described by the set of matched place records. With respect to the place data process pipeline, an embodiment described herein may be used to filter out non-relevant place records received from each data source prior to place records being matched and combined. Alternatively, an embodiment described herein may be used to filter out non-relevant place records subsequent to place records from different data sources being matched and combined.

For some embodiments, the at least one classifier comprises a binary classifier such that a prediction score that surpasses a predetermined classification threshold indicates a given place record's association with a positive class, and a prediction score that does not surpass the predetermined classification threshold indicates the given place record's association with a negative class. Depending on the embodiment, the positive class may represent relevance and the negative class may represent non-relevance, or vice versa. Additionally, some embodiments may include a score range such that a prediction score that surpasses the upper bound of the range indicates a given place record's association with a positive class, a prediction score that does not surpass the lower bound of the score range indicates the given place record's association with a negative class, and a prediction score that is within the score range indicates that the given place record's association is ambiguous and can be associated either positively or negatively. A place record having an ambiguous class association may be a place record describing a place that, with minimal analysis or evidence (e.g., online evidence), can be moved into the positive class, moved into the negative class, ignored, or removed (e.g., from storage) altogether.

For some embodiments, at least one class (e.g., positive, negative, or ambiguous class) comprises a plurality of sub-labels which can explain why the given place record is labeled a certain way. Such sub-labels can reduce ambiguity in labeling and may be used for detailed analysis. Detailed analysis can include, for example, comparing the specific features between relevant place records that are sub-labeled as open versus relevant place records that are sub-labeled closed, or comparing the specific features between non-relevant records that are sub-labeled private versus non-relevant records that are sub-labeled temporary events.

Table 1 below provides examples of positive class sub-labels that may be used by an embodiment.

TABLE 1

| Example Positive | |
|---|---|
| Class Sub-Label | Sub-Label Description |
| RELEVANT | This sub-label is associated with a place |
| | record describing a place that is a |
| | customer-facing, commercial location, |
| | such as a store, restaurant, or an office |
| | building, or a public place, such as a |
| | park, downtown area, or a stadium. The |
| | place record is assumed to be correctly |
| | named and to have reasonably accurate |
| | address information, which may be |
| | confirmed by an authority website or |
| | street-side imagery. |
| RELEVANT - INCORRECT | This sub-label is associated with a place |
| LOCATION | record describing a place that exists but |
| | the place record has outdated or |
| | incorrect location information (e.g., |
| | place may have moved from its original |
| | location). The place's existence and |
| | correct address may be confirmed by an |
| | Internet-based search. |
| RELEVANT - CLOSED | This sub-label is associated with a place |
| | record describing a place that is closed |
| | (e.g., reasonably recently), and this |
| | closure may be confirmed. This place |
| | may be associated with a franchise (e.g., |
| | local or national chain) and the place |
| | may be a specific franchise location that |
| | has been closed. The closure may be |
| | stated, for example, in a news article. |
| RELEVANT - PRIVATE | This sub-label is associated with a place |
| PRACTICE | record describing a place associated |
| | with a private practice by a professional, |
| | such as a physician, a therapist, a dentist, |
| | or an attorney. These place records may |
| | be confirmed based on affiliation with |
| | an open clinic or business, such as by |
| | being listed on an official website. |

Table 2 below provides examples of negative class sub-labels that may be used by an embodiment.

TABLE 2

| Example Negative | |
|---|---|
| Class Sub-Label | Sub-Label Description |
| NOT RELEVANT - | This sub-label is associated with a place |
| PRIVATE LOCATION | record describing a place that is a private |
| | location (e.g., private residence) and the |
| | place record includes a proper name for |
| | the place (e.g., a fancy name for an |
| | individual's house, such as “Joe's party |
| | house”). Such places may include |
| | private locations from which an |
| | individual operates a business (e.g., |
| | private contractor or one-person |
| | business). |
| NOT RELEVANT - | This sub-label is associated with a place |
| TEMPORARY | record describing a location of a |
| | temporary or one-time event, such as a |
| | marathon, race, festival, sports event, or |
| | concert. |
| NOT RELEVANT - DOES | This sub-label is associated with a place |
| NOT EXIST | record describing a non-existent place. |
| | The described place may have no online |
| | presence or an associated authority site. |
| | Such place records may have vague |
| | descriptions or names (es., “favorite |
| | sunset spot” or “work”). |

Table 3 below provides examples of ambiguous sub-labels that may be used by an embodiment.

TABLE 3

| Example Ambiguous Sub-Label | Sub-Label Description |
|---|---|
| MINIMAL - SMALL | This sub-label is associated with a place |
| BUSINESS | record describing a place that is a small |
| | business, such as one that does not have |
| | an online presence. Such a place may or |
| | may not be open, may or may not have |
| | an official website, but may be |
| | mentioned on a non-authority website. |
| MINIMAL - PRIVATE | This sub-label is associated with a place |
| PRACTICE | record describing a professional |
| | individual, such as a physician or |
| | attorney, who is not affiliated with a |
| | practice. This professional individual |
| | may have an online rating, such as on a |
| | non-authority website, but there may be |
| | no official website. |

As noted herein, one or more features for a given place record may be generated based on one or more attribute values of a place record. For instance, a feature may comprise a value extracted from, or a value derived based on, one or more values of one or more attributes (hereafter, “attribute values”) of the given place record. Additionally, at least one feature in the set of features may be normalized (e.g., between a value range of 0 to 1) to facilitate its use by a classifier according to an embodiment. For instance, a feature may be generated by extracting an attribute value from a place record, the attribute value being normalized between a range of 0 and 1.

For various embodiments, the set of features generated for a place record include one or more features that are determined (e.g., by offline regression analysis) to be useful in identifying relevant or non-relevant place records. The one or more attributes selected for use during generation of the one or more features may be less than all the attribute values included in a given place record. Selection of attributes used for feature generation of a particular feature may depend on the data source providing the given place record. For example, a particular feature may be generated for a first place record provided by a first data source (e.g., managed by a first third-party) based on values from a first set of attributes of the first place record, while the same particular feature may be generated for a second place record provided by a second data source (e.g., managed by a second third-party) based on values from a second (alternative) set of attributes of the second place record. The first and second sets of attributes may overlap or be mutually exclusive with respect to the attributes they include. An attribute included in place records provided by a first data source may not be an attribute included in place records provided by a second data source, and vice versa. Additionally, a particular feature generated for a first place record provided by a first data source may not be a feature generated for a second place record provided by a second data source.

Examples of features generated (e.g., by extraction or derivation) for a place record can include, without limitation: whether information is missing (e.g., whether a website address is missing from the place record or whether a portion of an address provided by the place record is missing, such as a street name, zip code, street number, or locality name); whether a locality name provided by the address is valid; whether the locality name provided by the address is found in all cities of a particular country (e.g., the U.S.); number of social media accounts associated with the described place; a characteristic of an attribute value (e.g., place name) provided by the place record (e.g., whether all in lower case, whether containing only numbers, number of words, or average length of each word); whether the place record provides an airport code (e.g., IATA code); whether an indication of a private location is present (e.g., “flight,” “house,” “spot,” or “trip” in an attribute value); whether an indication of a temporary event is present (e.g., marathon, concert, festival, voting, meeting, 5 k, or 10 k); whether an indication of a private practice is present (e.g., “MD,” “PhD,” “PA,” “CPA,” “OTR,” “CRNA,” or “LCPC” in an attribute value); whether there is a fuzzy match between a website address provided by the place record and the place name provided by the place record (e.g., it is a strong indication that the described place exists and is current when a website URL matches the place's name based on a normalized Levenshtein score); whether the place described is associated with a franchise (e.g., is a chain store or restaurant); a count for the number of times the place described by the place record has been visited by a unique individual; a category identifier (e.g., “education,” “shops and services,” etc.) associated with the place described by the place record; whether the category identifier is provided; zoning associated with the place described by the place record; whether there is a fuzzy match between information in the place record and text on a website associated with the place described by the place record (e.g., fuzzy match between place address, locality, or zip code); a score provided by the place record that represents the trustworthiness of the information included in the place record; a rank value provided by the place record for the place described; and a score provided by the place record representing the certainty that the place described exists.

During use, an embodiment may permit the addition of one or more new features not previously generated or considered by the embodiment when determining relevance of place records. The addition of one or more new features to an embodiment can assist the embodiment in more effectively determining the relevance of place records. For some embodiments, forward feature selection is utilized to determine the number of different features that should be generated for a place record to achieve desirable performance by the classifier.

Depending on the embodiment, one or more features generated for a place record may be those extracted or derived based on one or more place record attribute values determined to have high correlation with one another. Such feature correlations may be determined by offline analysis of sample place records (e.g., from a ground truth collection) that have been confirmed to be relevant or non-relevant.

Reference will now be made in detail to embodiments of the present disclosure, examples of which are illustrated in the appended drawings. The present disclosure may, however, be embodied in many different forms and should not be construed as being limited to the embodiments set forth herein.

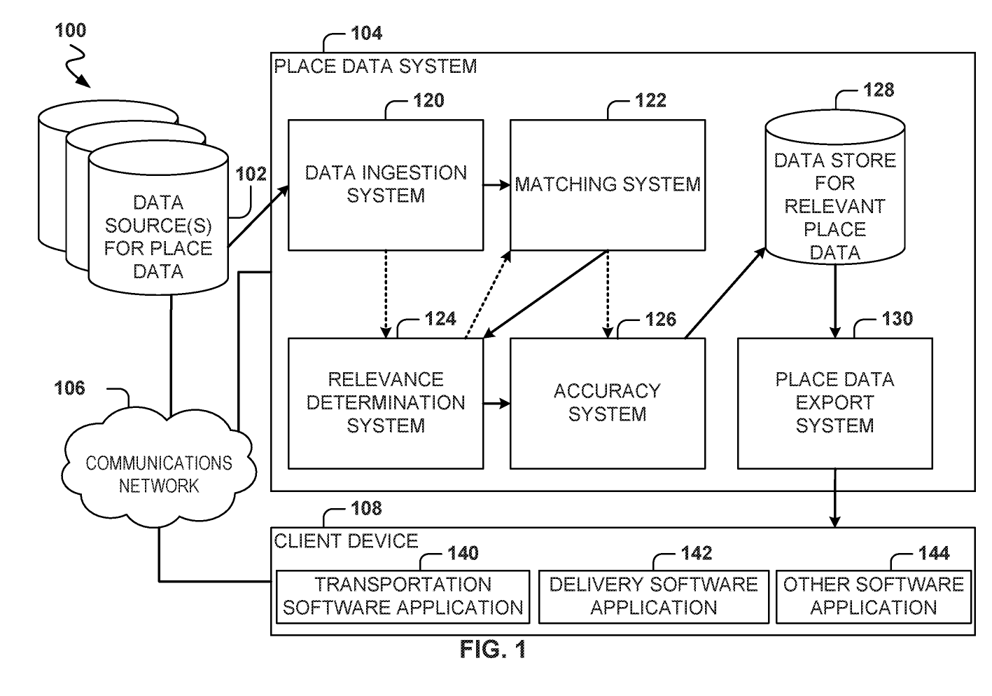

FIG. 1 is a block diagram illustrating an example networked computing environment 100 that includes a place data system 104, according to some embodiments. As shown, the place data system 104 is part of the networked computing environment 100 that includes one or more data sources 102 for place data, a client device 108, and a communications network 106 communicatively coupled to the place data system 104, the data sources 102, and the client device 108 to facilitate communication therebetween. The communications network 106 may comprise one or more local or wide-area communications networks, such as an ad hoc network, an intranet, an extranet, the Internet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, or a Wi-Fi® network. Additionally, although only one client device 108 is illustrated, it will be appreciated that the networked computing environment 100 could include two or more additional client devices.

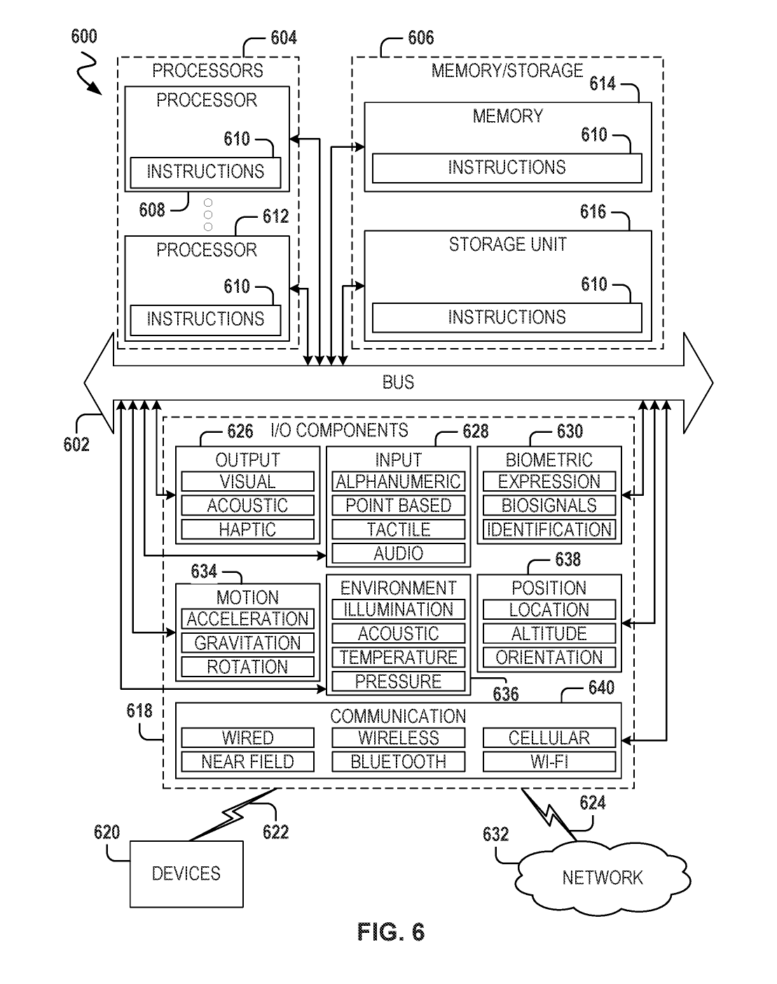

The data sources 102 provide the place data system 104 with place data (e.g., place records) for determining relevance of the place data for a particular use, such as use by a specific type of service. For some embodiments, the data sources 102 are implemented by one or more machines (e.g., networked machines), which may be similar to a machine 600 described herein with respect to FIG. 6. The data sources 102 can include one or more data sources maintained or operated by an entity that is a third party with respect to an entity operating the place data system 104, or an entity intending to use relevant place data (e.g., relevant place records). Additionally, the data sources 102 can include one or more data sources that collect and store place data generated or maintained by crowd-sourcing, where a plurality of users (e.g., user base) can directly or indirectly input information to be included in the place data. Examples of data sources for crowd-sourced place data can include, without limitation, location search and location discovery services, such those provided by FOURSQUARE or social network services (e.g., FACEBOOK or TWITTER). One or more of the data sources 102 may comprise one or more datastores. As used herein, a datastore can include any organization of data stored on a data storage device, such as tables, comma-separated values (CSV) files, databases (e.g., SQL or NoSQL-based database systems), or other known organizational data formats. Datastores can include data structures that provide a particular way of storing and organizing data such that the data can be used efficiently within a given context. As noted herein, place data may be maintained as one or more place data records, where each place record can comprise data regarding a single place located on a geographic map.

The place data system 104 comprises a data ingestion system 120, a matching system 122, a relevance determination system 124, an accuracy system 126, a data store 128 for relevant place data, and a place data export system 130. According to some embodiments, the place data system 104 ingests place data (e.g., in the form one or more place records) from the data sources 102, determines relevance of the ingested place data, and provides (e.g., exports) relevant place data for use by one or more software applications that provide, support, or otherwise facilitate a service, such as a mapping service, a transport/transportation arrangement service, or a delivery service. For some embodiments, the place data system 104 is implemented by one or more machines (e.g., networked machines), which may be similar to the machine 600 described herein with respect to FIG. 6.

The data ingestion system 120 accesses place data (e.g., place records) from the data sources 102, thereby permitting the place data system 104 to ingest place data from at least one of the data sources 102. The data ingestion system 120 may include one or more data interfaces, such as a database interface, that facilitate the system 120's access to data stored on at least one of the data sources 102.

The matching system 122 receives a plurality of place records and identifies (e.g., matches) place records that refer to the same physical location on a geographic map. In this way, the matching system 122 can determine a set of matched placed records that refer to the same physical location on the map. As described herein, place records may be matched, for instance, based on one or more attribute values included in place records, such as place names, place addresses, place types, or place geographic coordinates. The plurality of place records received by the matching system 122 may originate from two or more different data sources in the data sources 102. As noted herein, place records accessed by the place data system 104 (e.g., via the data ingestion system 120) can be sourced from multiple data sources (e.g., third-party providers) that are part of the data sources 102. For some embodiments, the matching system 122 combines the information of a set of matched place records that refer to the same physical location on a geographic map and generates a single place record to describe the place corresponding to the physical location and originally described by the set of matched place records. Combining a set of matched place records to generate a single place record may comprise, for instance, selecting the best latitude and longitude coordinates for the place, best name for the place, and the best address for the place.

The relevance determination system 124 receives a place record and determines whether the place record is relevant or non-relevant for a specific use, such as use by a software application that provides, supports, or otherwise facilitates a service, such as a mapping service, a transport/transportation arrangement service, or a delivery service. According to various embodiments, a set of features is generated (e.g., derived or extracted) based on values of one or more attributes (e.g., record field or fields) included in the received place record. For some embodiments, the received place record is processed by a machine learning (ML) model, such as a classifier. The ML model can receive as input the generated set of features of the received place record and can output a prediction score that indicates the certainty or probability that the received place record is associated with, or belongs to, a particular class (e.g., class label). In this way, the set of features of the received place record can function as signals or suggestions for or against the class association. The certainty/probability of association between the received place record and the particular class assists some embodiments in determining whether the received place record is relevant or non-relevant. Where the particular class indicates that the received place record is relevant, a prediction score for the received place record may represent the received place record's relevance score. Additionally, where the particular class indicates that the received place record is relevant, the prediction score can also represent the received place record's trustworthiness, which can determine how much weight is given to the received place record's attribute values.

Where the ML model comprises a binary classifier, the binary classifier can associate the place record received by the place data system 104 to a positive or a negative class, where the positive class (e.g., positive class label) represents that the received place record is relevant, and where the negative class (e.g., negative class label) represents that the received place record is not relevant. The ML model may comprise two or more binary classifiers, and each binary classifier may be associated with its own positive and negative class labels. The binary classifier can further associate the received place record to an ambiguous class, which can indicate that the received place record can be moved into the positive class, moved into the negative class, ignored, or removed with some analysis (e.g., analysis by a human individual). At least one class comprises a plurality of sub-labels that can explain why the given place record is labeled a certain way. Example sub-labels for positive, negative, and ambiguous classes can include, without limitation, those listed in Tables 1-3.

The accuracy system 126 receives a place record and determines an accuracy of the received place record. For some embodiments, the accuracy system 126 determines the accuracy of the received place record based on a set of criteria. An example criterion can include, without limitation, accuracy of geographic coordinates (e.g., latitude and longitude coordinates) included in the received place record. Depending on the embodiment, the place data system 104 can use the accuracy system 126 to filter out place records that fail to satisfy a predetermined accuracy threshold.

The data store 128 for relevant place data receives a place record and stores the received place record for subsequent use, such as by a location-based service. For some embodiments, one or more place records received by the data store 128 are those determined to be relevant by the relevance determination system 124. The place records determined to be relevant and stored on the data store 128 may be those already processed and determined by the accuracy system 126 to satisfy one or more accuracy criteria. In addition to storing a place record, the data store 128 can store a probability that the place record is relevant. The probability, which may be used as a relevance score, may be generated by the relevance determination system 124.

The place data export system 130 accesses the data store 128 and provides (e.g., exports) one or more place records from the data store 128 to one or more client devices, such as the client device 108. The place data export system 130 may provide a set of place records on demand by a client device or push the set of place records to a client device. For instance, the set of place records may be provided to the client device 108 in response to a search request submitted by the client device 108 (e.g., a search for a place to eat). For some embodiments, the one or more place records provided to a client device are relevant for use by a software application associated with a service, such as a mapping service, a transportation or transportation arrangement service, a delivery service, or a directory service.

During operation according to some embodiments, a set of place records flows through the place data system 104, from the data ingestion system 120, to the matching system 122, to the relevance determination system 124, to the accuracy system 126, and to the data store 128. In this way, the set of records can be matched and combined by the matching system 122 prior to being evaluated for relevance by the relevance determination system 124. Alternatively, during operation according to some embodiments, a set of place records flows through the place data system 104 from the data ingestion system 120, to the relevance determination system 124, to the matching system 122, to the accuracy system 126, and to the data store 128. In this way, the set of records can be evaluated for relevance by the relevance determination system 124 prior to the matching system 122.

For some embodiments, the client device 108 comprises one or more machines (e.g., networked machines), which may be similar to the machine 600 described herein with respect to FIG. 6. For instance, the client device 108 may comprise a user device, such as a mobile phone, desktop computer, laptop, a portable digital assistant (PDA), smart phone, a tablet, an ultrabook, a netbook, a microprocessor-based or programmable consumer electronic device, a game console, a set-top box, or another communication device that a user may use to access the communications network 106. In some embodiments, the client device 108 comprises a display interface (not shown) to display information (e.g., in the form of user interfaces). In further embodiments, the client device 108 comprises one or more touch screens, accelerometers, gyroscopes, cameras, microphones, global positioning system (GPS) devices, and the like. The client device 108 may be a device of a user that is used to access a location-based service, such as a mapping service, a transportation or transportation arrangement service, a delivery service, or a directory service. A user of the client device 108 may comprise a human individual or a machine.

The client device 108 may include one or more software applications such as, but not limited to, a web browser, a messaging application, an electronic mail (e-mail) application, and the like. As shown, the client device 108 comprises a transportation software application 140, a delivery software application 142, and other software application 144.

The transportation software application 140 provides, supports, or otherwise facilitates a transportation or transportation arrangement service. For instance, in the context of a ride service, the transportation software application 140 may comprise a software application used by a ride requester (e.g., rider), a ride provider (e.g., a driver), or both (e.g., by a software application that has different modes) to facilitate a ride from a pick-up location to a destination. For example, the transportation software application 140 can use relevant place data (e.g., place records), provided by the place data system 104, to enable a ride requester to set a pick-up location or a destination, described by the relevant place data, for a requested ride.

The delivery software application 142 provides, supports, or otherwise facilitates a delivery service, such as a service for delivering food or a package. For example, in the context of a food delivery service, the delivery software application 142 may comprise a software application used by a food requester (e.g., restaurant patron), a food provider (e.g., a restaurant customer), or both (e.g., software application has different modes) to facilitate food delivery. For example, the delivery software application 142 can use relevant place data (e.g., place records), provided by the place data system 104, to enable a restaurant customer to search for a restaurant described by the relevant place data, and submit to that restaurant a request for food delivery to a destination described by the relevant place data.

The other software application 144 represents a software application that can provide, support, or otherwise facilitate another type of service for a user of the client device 108. Another type of service may include a mapping service that provides the user with directions from their current location to a place located on a geographic map using relevant place data provided by the place data system 104. Yet another type of service may include a directory service that provides the user with directory and location information for places on a geographic map using relevant place data provided by the place data system 104.

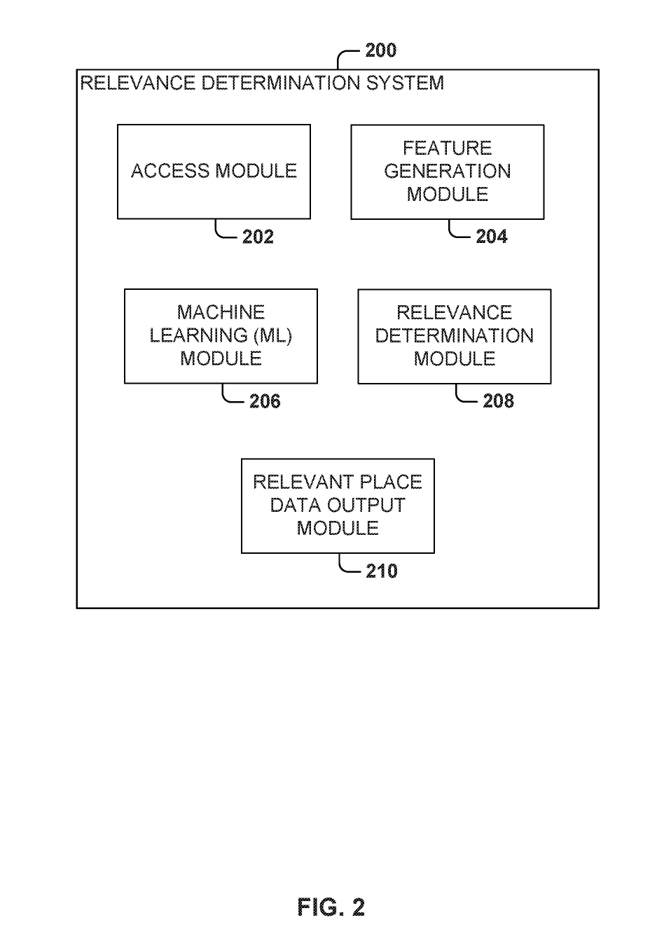

FIG. 2 is a diagram illustrating an example relevance determination system 200 for determining relevance of place data, according to some embodiments. For some embodiments, the relevance determination system 124 described with respect to FIG. 1 comprises the relevance determination system 200. As shown, the relevance determination system 200 comprises an access module 202, a feature generation module 204, a machine learning (ML) module 206, a relevance determination module 208, and a relevant place data output module 210. Though the relevance determination system 200 is described and depicted herein as including specific components and details, for some embodiments, the relevance determination system 200 is practiced according to different details, or with more, less, or different components than those shown.

The access module 202 accesses a particular place record for which relevance needs to be determined. In some instances, the particular place record accessed by the access module 202 may be one resulting from a process that matches different place records referring to the same place and combines them into the particular place records. The feature generation module 204 generates a set of features for the particular place record based on at least one value (e.g., extracted or derived) from an attribute included in the particular place record. The ML module 206 processes the set of features using a ML model, such as a classifier, to generate a probability that the particular place record is associated with a class label. The relevance determination module 208 determines, by the one or more hardware processors, whether the particular place record is relevant based on at least the probability that the particular place record is associated with a class label.

The relevant place data output module 210 can designate a particular place record as relevant in response to the relevance determination module 208 determining that the particular place record is relevant. Additionally, the relevant place data output module 210 can designate a particular place record as non-relevant in response to the relevance determination module 208 determining that the particular place record is not relevant. The relevant place data output module 210 can cause a particular place record, determined to be relevant by the relevance determination module 208, to be stored on a data store for subsequent use, such as a software application associated with a service. Additionally, for a particular place record determined to be relevant, the relevant place data output module 210 can cause data storage of a probability (e.g., generated by the ML module 206) that the particular record is associated with a class label indicating that the particular place record is relevant.

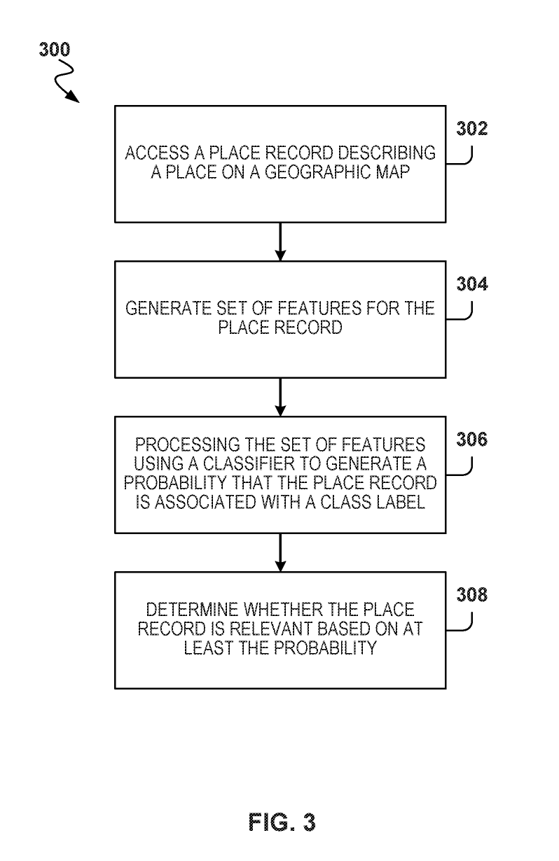

FIGS. 3-5 are flowcharts illustrating example methods for determining relevance of a place record, according to some embodiments. It will be understood that example methods described herein may be performed by a device, such as a server executing instructions of a transportation or transportation arrangement system. Additionally, example methods described herein may be implemented in the form of executable instructions stored on a computer-readable medium or in the form of electronic circuitry. For instance, the operations of a method 300 of FIG. 3 may be represented by executable instructions that, when executed by a processor of a computing device, cause the computing device to perform the method 300. Depending on the embodiment, an operation of an example method described herein may be repeated in different ways or involve intervening operations not shown. Though the operations of example methods may be depicted and described in a certain order, the order in which the operations are performed may vary among embodiments, including performing certain operations in parallel.

Referring now to FIG. 3, the flowchart illustrates the example method 300 for determining relevance of place data, according to some embodiments. In particular, the method 300 may be used to determine the relevance of one or more place records provided by one or more data sources (e.g., the data sources 102 of FIG. 1). For some embodiments, the method 300 is performed by the place data system 104 described above with respect to FIG. 1. An operation of the method 300 may be performed by one or more hardware processors (e.g., central processing unit or graphics processing unit) of a computing system.

The method 300 as illustrated begins with operation 302 (e.g., the access module 202) accessing a particular place record from at least one data source, where the particular place record describes a particular place on a geographic map. The at least one data source may include a place record that is generated or maintained by a plurality of human users. For instance, a place record on the at least one data source may be crow-sourced, whereby one or more fields of the place record may be populated or periodically updated by one or more users (e.g., by way of a location search or discovery service, such as one provided by FOURSQUARE). As noted herein, place data generated or maintained by users may have missing information (e.g., missing field values), include inaccurate information (e.g., outdated field values), or include fabricated information (e.g., fabricated field values).

The method 300 continues with operation 304 (e.g., the feature generation module 204) generating a set of features for the particular place record (accessed during operation 302) based on at least one value from an attribute included in the particular place record. For some embodiments, generating the set of features for the particular place record comprises extracting at least one value from an attribute (e.g., field) of the accessed particular place record. Additionally, for some embodiments, generating the set of features for the particular place record comprises deriving a feature value based on values from one or more attributes (e.g., fields) of the accessed particular place record.

The method 300 continues with operation 306 (e.g., the machine learning module 206) processing the set of features, generated by operation 304, using a classifier to generate a probability that the particular place record is associated with a class label. The classifier may output a probability that the particular place record is associated with the class label. As noted herein, the class label can assist with determining the relevance of the particular place record. For example, the class label can represent that the particular place record is relevant to transportation or transportation arrangement services, such as a ride or ride-sharing service. In particular, the class label may represent that: the particular place record is relevant and describes an incorrect location for the particular place; the particular place record is relevant and describes that the particular place is closed; the particular place record is relevant and describes that the particular place is a private practice; the particular place record is not relevant to a transportation/transportation arrangement service; the particular place record is not relevant and describes that the particular place is a private location; the particular place record is not relevant and describes a temporary event; or the particular place record describes that the particular place does not exist.

For some embodiments, the classifier comprises one or more binary classifiers, where each classifier may be associated with its own positive and negative class label. The classifier may be trained on ground truth data comprising a set of place records (e.g., approximately three thousand place records) and a set of corresponding class labels curated by a human individual.

The method 300 continues with operation 308 (e.g., the relevance determination module 208) determining whether the particular place record is relevant based on at least the probability (generated by operation 306) that the particular place record is associated with a class label.

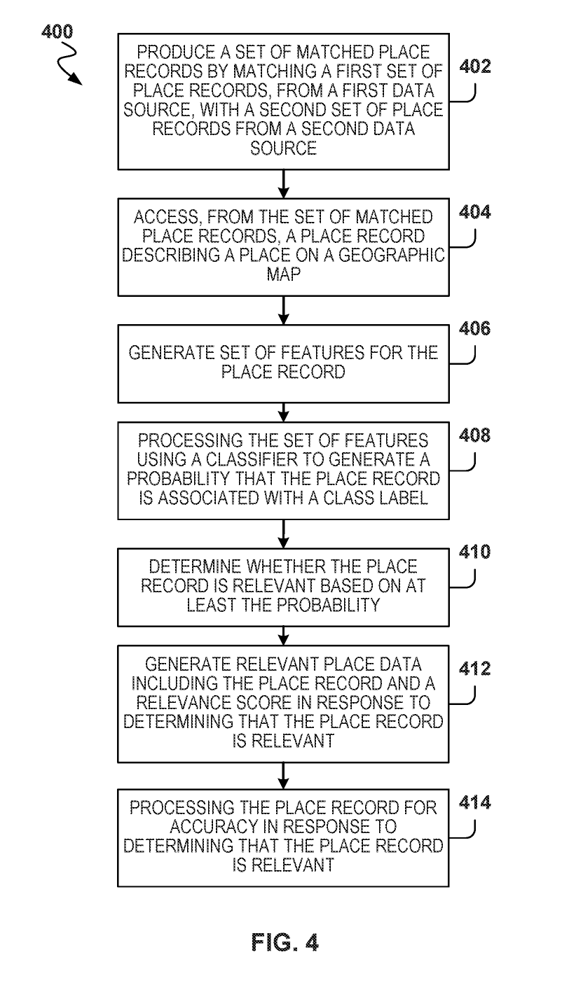

Referring now to FIG. 4, the flowchart illustrates the example method 400 for determining relevance of place data, according to some embodiments. Like the method 300, the method 400 may be used to determine the relevance of one or more place records provided by one or more data sources (e.g., the data sources 102 of FIG. 1). Additionally, the method 400 may be performed by the place data system 104 described above with respect to FIG. 1. An operation of the method 400 may be performed by one or more hardware processors of a computing system. The method 400 illustrates some embodiments that match and combine place records prior to the resulting place records being evaluated for relevance.

The method 400 as illustrated begins with operation 402 (e.g., the matching system 122) producing a set of matched place records. According to some embodiments, the set of matched place records comprises matching a first set of place records, from a first data source of place records (e.g., one of the data sources 102), with a second set of place records from a second data source of place records (e.g., another one of the data sources 102). The matching the first set of place records with the second set of place records may comprise matching a first place record, from the first set, to a second place record, from the second set, based on attribute values from the first place record and attribute values from the second place record.

The method 400 continues with operation 404 (e.g., the access module 202) accessing a particular place record from the set of matched place records produced by operation 402. Subsequently, the method 400 continues with operations 406-410, which, according to some embodiments, are respectively similar to operations 304-308 of the method 300 described above with respect to FIG. 3.

After operation 410, the method 400 continues with operation 412 (e.g., the relevant place data output module 210) generating relevant place data in response to operation 410 determining that the particular place record is relevant. For some embodiments, the relevant place data includes the particular place record and an associated relevance score based on the probability generated at operation 408. Depending on the embodiment, the relevant place data may be stored on a data store for subsequent use by a software application associated with a service, or may be processed by operation 414.

After operation 412, the method 400 continues with operation 414 (e.g., the accuracy system 126) processing the particular place record (e.g., as stored in the relevant place data) for accuracy, which may be determined based on a set of accuracy criteria. The set of accuracy criteria can include, without limitation, accuracy of geographic coordinates described by the particular place record.

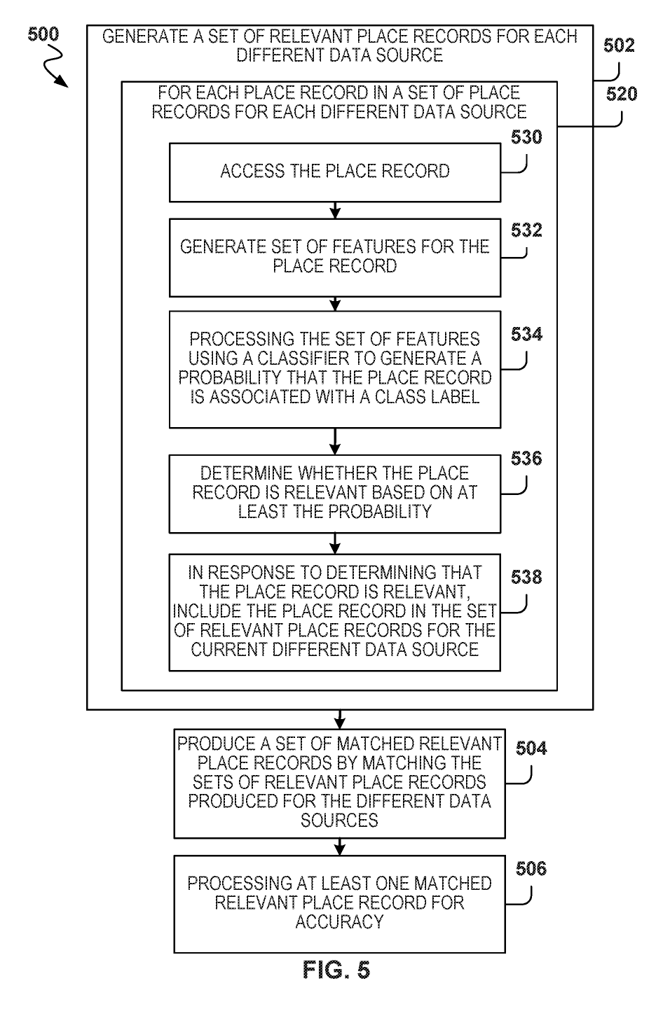

Referring now to FIG. 5, the flowchart illustrates the example method 500 for determining relevance of place data, according to some embodiments. Like the method 300, the method 500 may be used to determine the relevance of one or more place records provided by one or more data sources (e.g., the data sources 102 of FIG. 1). Additionally, the method 500 may be performed by the place data system 104 described above with respect to FIG. 1. An operation of the method 500 may be performed by one or more hardware processors of a computing system. The method 500 illustrates some embodiments that evaluate place records for relevance prior to relevant place records being matched and combined.

The method 500 as illustrated begins with operation 502 with the x component generating a set of relevant place records for each different data source (e.g., each data source in the data sources 102). According to some embodiments, operation 502 generates a set of relevant place records for each different data source by operations 520-538. In particular, operation 520 includes operations 530-538 performed for each place record in a set of place records for each different data source. For some embodiments, operations 530-536 are respectively similar to operation 302-308 of the method 300 described above with respect to FIG. 3. In response to determining that a place record is relevant by operation 536 based on at least the probability generated by operation 534, operation 538 includes the place record in the set of relevant place records for the current different data sources. Once operations 530-538 have been performed on each place record in a set of place records, for each different data source, the set of relevant place records may be provided by operation 502.

The method 500 continues with operation 504 with the x component producing a set of matched relevant place records by matching the sets of relevant place records resulting from operation 502. The matching the sets of relevant place records may comprise matching and combining together (e.g., combining the information) place records, in the sets of relevant place records, that refer to the same place, thereby generating a single place record for each physical location.

The method 500 continues with operation 506 with the x component processing at least one place record, from the set of matched relevant place records produced by operation 504, for accuracy, which may be determined based on a set of accuracy criteria. As noted herein, the set of accuracy criteria can include, without limitation, accuracy of geographic coordinates described by the at least one place record.

FIG. 6 is a block diagram illustrating components of the machine 600, according to some embodiments, able to read instructions from a machine-readable medium (e.g., a machine-readable storage medium) and perform any one or more of the methodologies discussed herein. Specifically, FIG. 6 shows a diagrammatic representation of the machine 600 in the example form of a computer system, within which instructions 610 (e.g., software, a program, an application, an applet, an app, or other executable code) for causing the machine 600 to perform any one or more of the methodologies discussed herein may be executed. For example, the instructions 610 may cause the machine 600 to execute the flow diagrams of other figures. Additionally, or alternatively, the instructions 610 may implement the servers associated with the services and components of other figures, and so forth. The instructions 610 transform the general, non-programmed machine 600 into a particular machine 600 programmed to carry out the described and illustrated functions in the manner described.

In alternative embodiments, the machine 600 operates as a standalone device or may be coupled (e.g., networked) to other machines. In a networked deployment, the machine 600 may operate in the capacity of a server machine or a client machine in a server-client network environment, or as a peer machine in a peer-to-peer (or distributed) network environment. The machine 600 may comprise, but not be limited to, a switch, a controller, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 610, sequentially or otherwise, that specify actions to be taken by the machine 600. Further, while only a single machine 600 is illustrated, the term “machine” shall also be taken to include a collection of machines 600 that individually or jointly execute the instructions 610 to perform any one or more of the methodologies discussed herein.

The machine 600 may include processors 604, memory/storage 606, and I/O components 618, which may be configured to communicate with each other such as via a bus 602. In an embodiment, the processors 604 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application-Specific Integrated Circuit (ASIC), a Radio-Frequency Integrated Circuit (RFIC), another processor, or any suitable combination thereof) may include, for example, a processor 608 and a processor 612 that may execute the instructions 610. The term “processor” is intended to include multi-core processors that may comprise two or more independent processors (sometimes referred to as “cores”) that may execute instructions contemporaneously. Although FIG. 6 shows multiple processors 604, the machine 600 may include a single processor with a single core, a single processor with multiple cores (e.g., a multi-core processor), multiple processors with a single core, multiple processors with multiples cores, or any combination thereof.

The memory/storage 606 may include a memory 614, such as a main memory, or other memory storage, and a storage unit 616, both accessible to the processors 604 such as via the bus 602. The storage unit 616 and memory 614 store the instructions 610 embodying any one or more of the methodologies or functions described herein. The instructions 610 may also reside, completely or partially, within the memory 614, within the storage unit 616, within at least one of the processors 604 (e.g., within the processor's cache memory), or any suitable combination thereof, during execution thereof by the machine 600. Accordingly, the memory 614, the storage unit 616, and the memory of the processors 604 are examples of machine-readable media.

As used herein, “machine-readable medium” means a device able to store instructions and data temporarily or permanently and may include, but is not limited to, random-access memory (RAM), read-only memory (ROM), buffer memory, flash memory, optical media, magnetic media, cache memory, other types of storage (e.g., Electrically Erasable Programmable Read-Only Memory (EEPROM)), and/or any suitable combination thereof. The term “machine-readable medium” should be taken to include a single medium or multiple media (e.g., a centralized or distributed database, or associated caches and servers) able to store the instructions 610. The term “machine-readable medium” shall also be taken to include any medium, or combination of multiple media, that is capable of storing instructions (e.g., instructions 610) for execution by a machine (e.g., machine 600), such that the instructions, when executed by one or more processors of the machine (e.g., processors 604), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 618 may include a wide variety of components to receive input, provide output, produce output, transmit information, exchange information, capture measurements, and so on. The specific I/O components 618 that are included in a particular machine will depend on the type of machine. For example, portable machines such as mobile phones will likely include a touch input device or other such input mechanisms, while a headless server machine will likely not include such a touch input device. It will be appreciated that the I/O components 618 may include many other components that are not shown in FIG. 6. The I/O components 618 are grouped according to functionality merely for simplifying the following discussion, and the grouping is in no way limiting. In various embodiments, the I/O components 618 may include output components 626 and input components 628. The output components 626 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 628 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and/or force of touches or touch gestures, or other tactile input components), audio input components (e.g., a microphone), and the like.

In further embodiments, the I/O components 618 may include biometric components 630, motion components 634, environmental components 636, or position components 638 among a wide array of other components. For example, the biometric components 630 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 634 may include acceleration sensor components (e.g., accelerometer), gravitation sensor components, rotation sensor components (e.g., gyroscope), and so forth. The environmental components 636 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 638 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 618 may include communication components 640 operable to couple the machine 600 to a network 632 or devices 620 via a coupling 624 and a coupling 622, respectively. For example, the communication components 640 may include a network interface component or other suitable device to interface with the network 632. In further examples, the communication components 640 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 620 may be another machine or any of a wide variety of peripheral devices (e.g., a peripheral device coupled via a Universal Serial Bus (USB)).

Moreover, the communication components 640 may detect identifiers or include components operable to detect identifiers. For example, the communication components 640 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 640, such as location via Internet Protocol (IP) geo-location, location via Wi-Fi® signal triangulation, location via detecting an NFC beacon signal that may indicate a particular location, and so forth.

In various embodiments, one or more portions of the network 632 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 632 or a portion of the network 632 may include a wireless or cellular network, and the coupling 624 may be a Code Division Multiple Access (CDMA) connection, a Global System for Mobile communications (GSM) connection, or another type of cellular or wireless coupling. In this example, the coupling 624 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third-Generation Partnership Project (3GPP) including 3G, fourth-generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data transfer technology.

The instructions 610 may be transmitted or received over the network 632 using a transmission medium via a network interface device (e.g., a network interface component included in the communication components 640) and utilizing any one of a number of well-known transfer protocols (e.g., hypertext transfer protocol (HTTP)). Similarly, the instructions 610 may be transmitted or received using a transmission medium via the coupling 622 (e.g., a peer-to-peer coupling) to the devices 620. The term “transmission medium” shall be taken to include any intangible medium that is capable of storing, encoding, or carrying the instructions 610 for execution by the machine 600, and includes digital or analog communications signals or other intangible media to facilitate communication of such software.

According to some embodiments, a method comprising: accessing a particular place record from a data source, the particular place record describing a particular place on a geographic map; generating a set of features for the particular place record based on a value from an attribute included in the particular place record; processing the set of features using a classifier to generate a probability that the particular place record is associated with a class label; and determining whether the particular place record is relevant based on at least the probability that the particular place record is associated with a class label.

The generating the set of features for the particular place record comprises extracting a value from an attribute of the particular place record. The classifier may comprise a binary classifier. The classifier may be trained on ground truth data comprising a set of place records and a set of corresponding class labels curated by a human individual. The data source may comprise a place record that is generated or maintained by a plurality of human users.

The method may further comprise, in response to determining that the particular place record is relevant, generating relevant place data that includes the particular place record and an associated relevance score, the associated relevance score being based on the probability.

The method may further comprise producing a set of matched place records by matching a first set of place records, from a first data source of place records, with at least a second set of place records from a second data source of place records, where the accessing the particular place record from the data source comprises accessing the particular place record from the set of matched place records.

The class label may represent that the particular place record is relevant to a ride-sharing service. The class label may represent that the particular place record is relevant and describes an incorrect location for the particular place. The class label may represent that the particular place record is relevant and describes that the particular place is closed. The class label may represent that the particular place record is relevant and describes that the particular place is a private practice. The class label may represent that the particular place record is not relevant to a ride-sharing service. The class label may represent that the particular place record is not relevant and describes that the particular place is a private location. The class label may represent that the particular place record is not relevant and describes a temporary event. The class label may represent that the particular place record describes that the particular place does not exist.

The method may further comprise in response to determining that the particular place record is relevant, processing the particular place record for accuracy, where the accuracy at least includes accuracy of geographic coordinates described by the particular place record.

The method may further comprise producing a set of relevant place records for each different data source in a plurality of data sources by performing the accessing of the particular place record, the generating of the set of features, the processing of the set of features, and the determining of whether the particular place record is relevant for each place record provided the different data source. The method may further comprise producing a set of matched relevant place records by matching together place records within the sets of relevant place records for the different data sources. The method may further comprise processing the set of relevant place records for accuracy, where the accuracy at least includes accuracy of geographic coordinates described by the particular place record.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

One or more embodiments described herein can be implemented using modules, engines, or components, which may be programmatic in nature. As used herein, a module, engine, or component can comprise a unit of functionality that can be performed in accordance with one or more embodiments described herein. A module, engine, or component might be implemented utilizing any form of hardware, software, or a combination thereof. Accordingly, a module, engine, or component can include a program, a sub-routine, a portion of a software application, or a software component or a hardware component capable of performing one or more stated tasks or functions. For instance, one or more hardware processors, controllers, circuits (e.g., ASICs, PLAs, PALs, CPLDs, FPGAs), logical components, software routines or other mechanisms might be implemented to make up a module, engine, or component. In implementation, the various modules/engines/components described herein might be implemented as discrete elements or the functions and features described can be shared in part, or in total, among one or more elements. Accordingly, various features and functionality described herein may be implemented in any software application and can be implemented in one or more separate or shared modules/engines/components in various combinations and permutations. Even though various features or elements of functionality may be individually described or claimed as separate modules, for some embodiments, these features and functionality can be shared among one or more common software and hardware elements. The description provided herein shall not require or imply that separate hardware or software components are used to implement such features or functionality.

As used herein, the term “or” may be construed in either an inclusive or exclusive sense. The terms “a” or “an” should be read as meaning “at least one”, “one or more”, or the like. The presence of broadening words and phrases such as “one or more”, “at least”, “but not limited to”, or other like phrases in some instances shall not be read to mean that the narrower case is intended or required in instances where such broadening phrases may be absent. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A method comprising:
accessing, by one or more hardware processors, a particular place record from a data source, the particular place record describing a particular place on a geographic map;
generating, by the one or more hardware processors, a set of features for the particular place record based on a value from an attribute included in the particular place record;
processing, by the one or more hardware processors, the set of features using a classifier to generate a probability that the particular place record is associated with a class label; and
determining, by the one or more hardware processors, whether the particular place record is relevant based on at least the probability that the particular place record is associated with a class label.

2. The method of claim 1, further comprising, in response to determining that the particular place record is relevant, generating, by the one or more hardware processors, relevant place data that includes the particular place record and an associated relevance score, the associated relevance score being based on the probability.

3. The method of claim 1, wherein the class label represents that the particular place record is relevant to a ride-sharing service.

4. The method of claim 1, wherein the class label represents that the particular place record is relevant and describes an incorrect location for the particular place.

5. The method of claim 1, wherein the class label represents that the particular place record is relevant and describes that the particular place is closed.

6. The method of claim 1, wherein the class label represents that the particular place record is relevant and describes that the particular place is a private practice.

7. The method of claim 1, wherein the class label represents that the particular place record is not relevant to a ride-sharing service.

8. The method of claim 1, wherein the class label represents that the particular place record is not relevant and describes that the particular place is a private location.

9. The method of claim 1, wherein the class label represents that the particular place record is not relevant and describes a temporary event.

10. The method of claim 1, wherein the class label represents that the particular place record describes that the particular place does not exist.

11. The method of claim 1, wherein the generating the set of features for the particular place record comprises extracting a value from an attribute of the particular place record.

12. The method of claim 1, further comprising producing a set of matched place records by matching a first set of place records, from a first data source of place records, with at least a second set of place records from a second data source of place records, wherein the accessing the particular place record from the data source comprises accessing the particular place record from the set of matched place records.

13. The method of claim 1, further comprising in response to determining that the particular place record is relevant, processing, by the one or more hardware processors, the particular place record for accuracy, wherein the accuracy at least includes accuracy of geographic coordinates described by the particular place record.

14. The method of claim 1, further comprising producing a set of relevant place records for each different data source in a plurality of data sources by performing the accessing of the particular place record, the generating of the set of features, the processing of the set of features, and the determining of whether the particular place record is relevant for each place record provided the different data source, wherein the method further comprises:
producing a set of matched relevant place records by matching together place records within the sets of relevant place records for the different data sources.

15. The method of claim 14, further comprising processing, by the one or more hardware processors, the set of relevant place records for accuracy, wherein the accuracy at least includes accuracy of geographic coordinates described by the particular place record.

16. The method of claim 1, wherein the classifier comprises a binary classifier.

17. The method of claim 1, wherein the classifier is trained on ground truth data comprising a set of place records and a set of corresponding class labels curated by a human individual.

18. The method of claim 1, wherein the data source comprises a place record that is generated or maintained by a plurality of human users.

19. A non-transitory computer storage medium comprising instructions that, when executed by a hardware processor of a device, cause the device to perform operations comprising:
accessing a particular place record from a data source, the particular place record describing a particular place on a geographic map;
generating a set of features for the particular place record based on a value from an attribute included in the particular place record;
processing the set of features using a classifier to generate a probability that the particular place record is associated with a class label; and
determining whether the particular place record is relevant based on at least the probability that the particular place record is associated with a class label.

20. A computer comprising:
a memory storing instructions; and
one or more hardware processors configured by the instructions to perform operations comprising:
accessing a particular place record from a data source, the particular place record describing a particular place on a geographic map;
generating a set of features for the particular place record based on a value from an attribute included in the particular place record;
processing the set of features using a classifier to generate a probability that the particular place record is associated with a class label; and
determining whether the particular place record is relevant based on at least the probability that the particular place record is associated with a class label.
